(19) United States
(12) Patent Application Publication
(10) Pub. No.: US 2002/0134740 A1
(43) Pub. Date: Sep. 26, 2002

(54) Inverted air box aerator and aeration method for immersed membrane

(76) Inventor: Pierre Cote, Dundas (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/061,108

(22) Filed: Feb. 1, 2002

Related U.S. Application Data
(60) Provisional application No. 60/278,007, filed on Mar. 23, 2001.

(51) Int. Cl. B01D 65/02

(52) U.S. Cl. 210/791; 210/797; 210/409; 210/410

(57) ABSTRACT

An aerator for filtering membranes immersed in a tank of liquid has an upper surface having holes for discharging bubbles below the membranes, sides extending downwardly from upper surface for trapping a variable volume of air in communication with holes and an opening to the liquid in the tank below the volume of trapped air so that liquid can be displaced from or enter into the aerator as the volume of trapped air changes. A supply of air is provided to the air space in the aerators alternating between a high flow rate and a low flow rate in short cycles of between about 10 seconds and 100 seconds. Typically, there is substantially no air flow during the period of low air flow. The aerator is sized in relation to the duration and rate of air flow provided during a cycle such that either air flows through the holes throughout each cycle or such that no air flows through the holes during at least part of the cycle such that liquid in the tank may flood the aerator and wash away any accumulated solids.

### FIELD OF THE INVENTION

This invention is useful for the aeration scouring of immersed filtering membranes including, without limitation, the ZeeWeed 500 series manufactured by ZENON Environmental Inc. and generally described in U.S. Pat. No. 5,639,373 issued Jun. 17, 1997 to Mahendran et al. and incorporated herein by this reference. It can be used in such applications as the filtration of surface water for the production water, or the filtration of activated sludge in membrane bio-reactors used for wastewater treatment.

### BACKGROUND OF THE INVENTION

Aeration is used with immersed membranes to scour the membranes and to disperse areas of tank water having increased concentrations of rejected solids from near the membranes. In particular, immersed membranes in bioreactors quickly become surrounded in sludge if intensive course bubble aeration is not provided. To be effective, aeration for immersed membranes must scour the entire assembly of membranes while minimizing cost and maintenance required to keep the aerators from plugging.

U.S. Pat. Nos. 5,192,456 and 5,482,625, issued on Mar. 9, 1993 and Jan. 9, 1996 to Kubota Corporation, describe an air diffuser disposed below a set of membrane cartridges. A casing surrounds the air diffuser and the membrane cartridges, extending vertically from the bottom of the diffuser to m top of the membrane cartridges. In commercial embodiments, the diffuser is locater about 1 m below the membrane cartridges and the diffusers provide a small number of holes per square meter of horizontal cross-sectional area of the assembly of membrane cartridges. Air is supplied such that the air velocity and pressure in the holes of the diffusers is sufficient to prevent water or sludge from creeping into the holes of the diffuser. The casing and location of the diffuser below the membrane cartridges encourages the bubbles to become evenly dispersed by the time that they reach the membrane cartridges. The shroud and deep aerators increase both the equipment cost and the energy required to produce bubbles. The method also relies on the membrane cartridges being arranged in parallel vertical plates for full effectiveness.

Another approach is described in U.S. Pat. No. 5,944,997, issued on Aug. 31, 1999 to Zenon Environmental Inc. In this patent, aerators are located directly below a set of membrane modules and no shroud is used but there are many more holes—about 130-160 holes per square meter of horizontal cross-sectional of the assembly of membrane modules. Although the large number of holes provides well distributed bubbles, the air flow per hole is not sufficient to prevent tank water or sludge from creeping into the aerators around the perimeter of the holes. To prevent this tank water from leaving deposits in the aerator, the aerators are periodically flushed with a two-phase mixture of air and permeate. Although effective, this method involves an extensive grid of aerators to provide the large number of holes and additional equipment for flushing aerators.

### SUMMARY OF THE INVENTION

It is an object of the invention to provide an improved aerator and aeration process for immersed filtering membranes. An inverted box with holes in its upper surface and open to tank water below it is placed underneath a membrane assembly. The box is fed with air varying between a high rate of air flow and a low rate of air flow in short cycles of between about 10 seconds and 100 seconds in duration, preferably between about 10 seconds and 60 seconds in duration. Air is preferably provided during about ⅛ to ½ of each cycle. Such cycling is described in PCT Application PCT/CA99/00940, published as WO 00/21890 and is incorporated herein by this reference.

When air is provided at a high rate of air flow, the box traps a pocket of air which grows in volume and releases bubbles from its upper surface. When air is provided at the low rate of air flow, the box continues to release bubbles from its upper surface and the volume of the air pocket decreases. The box may become flooded during a later part of the low air flow period. Preferably, bubbles are provided during about ⅓ to ⅔ of the cycle duration.

### BRIEF DESCRIPTION OF THE DRAWINGS

For a better understanding of the present invention, and to show more clearly how it may be carried into effect, reference will now be made by way of example to an embodiment illustrated in the accompanying drawings in which:

FIG. 1 is a cross-sectional view of a membrane assembly 1, an air box 2 and an air distribution pipe 3.

FIG. 2 is the design for the air box showing the distribution of holes 5 and the nipples 4.

### DETAILED DESCRIPTION OF EMBODIMENTS

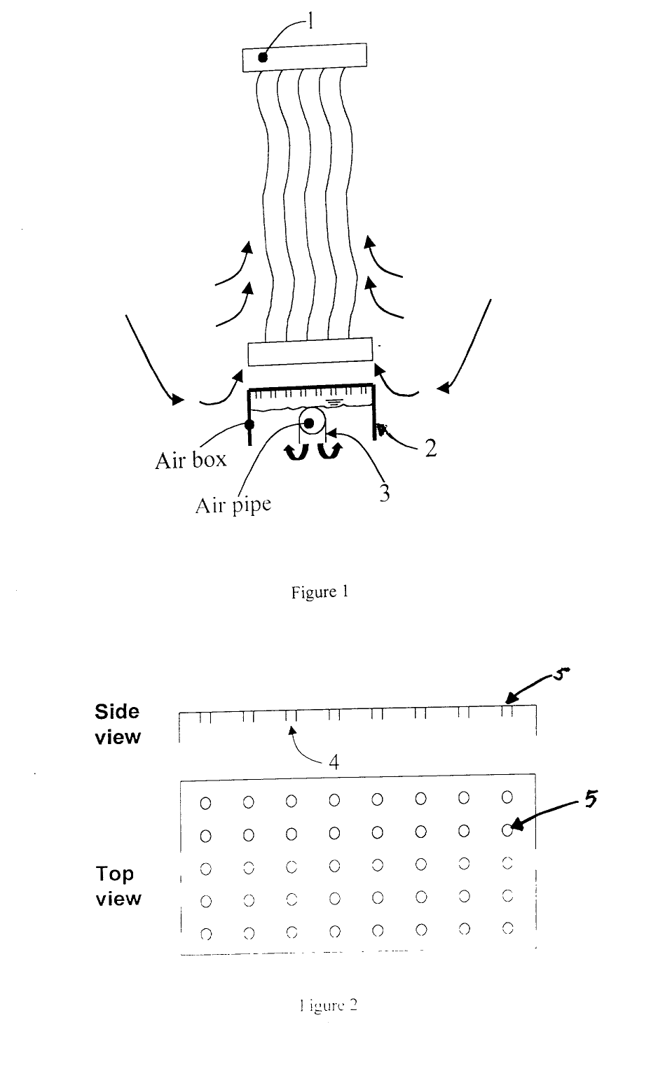

Referring to FIG. 1, the air box 2 is located below the membrane assembly 1. A space between the membrane assembly 1 and the air box 2 promotes liquid recirculation through and about the membrane assembly 1. The air box 2 is preferably rectangular but may be other shapes capable of supporting holes 5 in desired locations in an upper surface, trapping a variable volume of air in communication with the holes 5 and open to tank water so that tank water can be displaced from or enter into the air box 2 as the volume of trapped air changes. The air box 2 has horizontal dimensions to generally match the footprint of the membrane assembly 1. The height of the side walls of the air box 2 is such that the air box 2 can contain a volume of air corresponding to the amount of air which is provided from the air distribution pipe 3 less the volume of air produced as bubbles through the holes 5 and nipples 4 as will be described further below.

The air distribution pipe 3 is located as close as possible to the air box 2 to limit the height of the water column (or pressure) which must be overcome to eject air and thereby minimize energy required.

The air box 2 may be attached to the membrane assembly 1 which facilitates inspection when the membrane assembly is pulled out, or to the air distribution pipe 3.

There is one large aeration hole in air distribution pipe 3 located under each air box 2. The air distribution pipe 3 feeds simultaneously several air boxes 2.

Referring to FIG. 2, the air box 2 upper surface has a series of air holes 5 arranged in a regular pattern. The hole size is such that the holes 5 do not plug from debris in water and scouring bubbles are produced (typically 5-15 mm). The density of holes 5 depends on design of the membrane assembly 1 and aeration requirements (typically 25 to 160 holes per square meter). The holes may be fitted with nipples 4 pointing downward to provide a residual air cushion in the air box 2 and promote the rapid horizontal dispersion of air.

In operation, the rate of air flow in the air distribution pipe 3 varies in a repeated cycle having a total cycle length or duration of between about 10 and 100 seconds. In general, there is a period at a high flow rate and a period at a low flow rate.

Preferably the rate of air flow during the period of low flow is 10% or less than the rate of an air flow during the period of high flow. More preferably, there is substantially no air flow during the period of low flow. The period of high flow is between about ⅛ and ½ of the total cycle duration. Most often, the period of high flow and period of low flow are each about ½ of the cycle duration. Further preferably, the change between the high flow and the low flow is performed rapidly, i.e. in less than about 6 seconds, more preferably in less than about 3 seconds.

During the high flow period, the air box 2 fills with air because the air flow from the air distribution pipe 3 is much larger than the air flow from the air box 2 as bubbles which flow upwards to the membrane assembly 1.

The air box continues to discharge air bubbles through the holes 5 to scour the membrane assembly 1 during the low/no flow period. The air box 2 may be sized (in relation to the number and size of holes 5 and the flow rate and duration of air flow from the air distribution pipe 3) such that air flows through the holes 5 throughout each cycle. Alternately, the air box 2 may be sized to become empty of air during a part of no/low flow period which allows tank water to flow thorough the holes 5 or nipples 4 to wash away deposits left around the holes 5 or nipples 4.

Air cycling may be provided to multiple, distinct groups of membrane assemblies 1 so as to provide varying rates of air flow to distinct air distribution pipes 3 from a single air blower operated at a single rate. This is done by providing a plurality of air distribution pipes 3 in communication with a plurality of distinct branches of an air distribution system. A valve set communicates between an air supply and the distinct branches. The valve set is operated to split an initial air flow from the air supply such that at any time at least one distinct branch receives air at a higher flow rate and at least one other of the branches receives air at a lower rate. The valve set switches which distinct branch or branches receives air at the higher flow rate and the lower flow rate in repeated cycles. This is described more fully in WO 00/21890 attached as Appendix “A”.

Because of the volume of air temporarily contained in the air box 2 during the high flow period, bubbles are produced for a greater portion of the cycle than the high flow period. For example, if two distinct branches are provided, the high flow period in each will be about ½ of the cycle duration but bubbles may be produced for between about ½ and ¾ of the cycle duration. Alternately, 4 distinct branches might be fitted to a single blower and each receive air at the higher flow rate for about ¼ of the cycle duration. Yet, because of the volume of air temporarily trapped in the air box 2, bubbles can be produced for about ⅓ to ½ of the cycle duration.

Benefits:

1. Avoid an aerator grid which requires a larger network of pipes.

2. Reduce the need to flush aerators with permeate to wash away deposits left by tank water entering the aerator as described in U.S. Pat. No. 5,944,997 issued on Aug. 31, 1999 to Pedersen et al.

3. Facilitates scale-up to aeration of a large set of membrane assemblies 1.

4. Decreases maintenance requirements since the air box 2 is easily cleaned and is generally self cleaning when permitted to flood periodically.

Embodiments may be made in alternate configurations and operated according to alternate methods within the scope of the invention which is defined by the following claims:

We claim:

1. An aerator for filtering membranes immersed in a tank of liquid, comprising:
a) an upper surface having holes for discharging bubbles below the membranes;
b) sides extending downwardly from the upper surface which surround a space for trapping a variable volume of air in communication with the holes; and
c) an opening to the liquid in the tank below the volume of trapped air so that liquid can be displaced from or enter into the aerator as the column of trapped air changes.

2. The aerator of claim 1 wherein the holes comprise nipples extending downwards from the upper surface so as to preserve a volume of trapped air even when no air is supplied to the aerator.

3. A method of aerating immersed filtering membranes comprising the steps of:
a) providing an aerator as described in any of claims 1 or 2; and
b) providing a supply of air to the space in the aerator wherein air may be trapped alternating between a high flow rate and a low flow rate in short cycles of between about 10 seconds and 100 seconds in duration.

4. The process of claim 3 wherein the rate of air flow during the period of low flow is 10% or less than the rate of air flow during the period of high flow.

5. The process of the claim 4 wherein there is substantially no air flow during the period of low air flow.

6. The process of any of claims 3, 4 or 5 wherein the period of high flow is between about ⅛ and ½ of the total cycle duration.

7. The process of any of claims 3, 4 or 5 process claims wherein the change between the high flow rate and low flow rate is performed in less than about 6 seconds.

8. The process of claim 7 wherein the change between the high flow rate and low flow rate is performed in less than about 3 seconds.

9. The process of any of claims 3 to 8 wherein the aerator is sized in relation to the duration and rate of air flow provided during a cycle such that air flows through the holes throughout each cycle.

10. The process of any of claims 3 to 8 wherein the aerator is sized in relation to the duration and rate of air flow provided during a cycle such that no air flows through the holes during at least part of the cycle such that liquid in the tank may flow into the holes.

11. The process of claim 10 wherein air flows through the holes of the aerator for between about ⅓ and ¾ of the cycle duration.

12. The process of claim 11 wherein air flows through the holes for about ½ of the cycle duration.
